(19) United States
(12) Patent Application Publication
(10) Pub. No.: US 2003/0200231 A1
(43) Pub. Date: Oct. 23, 2003

(54) Program file management system

(76) Inventors: Masaki Deguchi, Kanagawa (JP); Seiji Nakazumi, Kawasaki (JP); Yoshinari Akakura, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/331,079

(22) Filed: Dec. 27, 2002

(30) Foreign Application Priority Data
Apr. 19, 2002 (JP) 2002-117389

(51) Int. Cl. G06F 12/00

(52) U.S. Cl. 707/200

(57) ABSTRACT

A program file management system capable of efficient management of multiple program files, thus permitting reduction in scale of the system and improving convenience. A memory has a starting area and a saving area, and a CPU section performs a switchover from the saving area to the starting area and executes operation in accordance with a program file stored in the starting area. In response to a program file store instruction, the CPU section transfers the program file under execution to the saving area of another unit to be stored therein in accordance with table information. A table database holds an address management table and a destination CPU selection table. An operation management section performs interfacing of commands from the user and performs control including downloading of program files to the CPU unit, registration of the table information in the table database and issuance of the program file store instruction.

### BACKGROUND OF THE INVENTION

1. Field of the Invention

The present invention relates to a program file management system, and more particularly, to a program file management system for managing a plurality of program files.

2. Description of the Related Art

With the recent diffusion of the Internet and broadband multimedia services such as delivery of digital contents, economical yet high-speed, large-capacity network systems are being developed at a quick pace.

In the circumstances, the scale of the system is rapidly expanding and also the functions of the system are diversifying, so that programs increase in size, making it difficult to control the system with one CPU unit.

In WDM (Wavelength Division Multiplex) systems which are recently attracting attention in the field of optical transmission, for example, 176 signals of 10 Gb/s are multiplexed for transmission, and one system may therefore comprise as many as 100 shelves or thereabouts when maximally configured.

Also, since control and switching need to be performed while at the same time a large number of signals are monitored at short intervals, the processing of the whole system cannot be taken care of by one CPU unit. Accordingly, a plurality of CPU units for performing different functions are provided to share the processing, and also since the number and size of program files are large, conventionally a dedicated memory unit is used to store all program files.

The program files are downloaded to the multiple CPU units and started thereby. FIG. 30 illustrates state transitions of program files, wherein program files are switched from version A to version B.

The illustrated system comprises CPU units 51 to 53 and a memory unit 60, and the CPU units 51 to 53 have respective memories 51a to 53a for storing program files. [State 5-a] A program file (version A1) for the CPU unit 51 is stored in a starting area of the memory 51a. Similarly, a program file (version A2) for the CPU unit 52 is stored in the starting area of the memory 52a, and a program file (version A3) for the CPU unit 53 is stored in the starting area of the memory 53a. [State 5-b] In accordance with instructions from a maintenance technician, program files of versions B1 to B3 for the CPU units 51 to 53, respectively, are written into the memory unit 60 as well as respective work areas (temporary storage areas) of the memories 51a to 53a.

[State 5-c] After the program files of versions B1 to B3 are stored in the memory unit 60 and the respective CPU units 51 to 53, instructions to start the versions B are given, whereupon the CPU units 51 to 53 perform a switchover between the starting and work areas, and start the program files of versions B1 to B3, respectively.

FIG. 31 illustrates state transitions of the program files at the time of restoration process, wherein because of a defect in a starting program file, the program file is restored using the one stored in the memory unit 60. The system configuration is identical with that described above.

At first, the program files of versions B1 to B3 are stored in the respective starting areas of the memories 51a to 53a, and the program files of versions A1 to A3 are stored in the respective work areas. Also, the memory unit 60 has the program files of versions B1 to B3 stored therein. [State 5-d] The CPU unit 51 recognizes that there is an anomaly in the program file (version B1) currently executed. [State 5-e] The CPU unit 51 newly loads, into the work area of its memory 51a, the program file (version B1) stored in the memory unit 60. [State 5-f] The CPU unit 51 performs a switchover between the starting and work areas, and starts the newly loaded program file of version B1.

In this manner, conventionally all program files are stored in the memory unit 60, and by communicating with the memory unit 60, the individual CPU units 51 to 53 read out the respective program files from the memory unit 60 to perform the required processes.

As described above, in the conventional program file management method, all program files of different kinds are stored in and managed by the dedicated memory unit 60, to allow switchover of program files during ordinary system operation or in case of restoration process performed when anomaly has occurred in a starting program file.

Accordingly, if the number and size of program files increase, the hardware of the memory unit 60 needs to be remodeled to increase the memory capacity, but this gives rise to a problem that the resulting enlargement in the scale of the system entails an increase of costs.

Also, the memory unit 60 is used for various purposes, and therefore, if the hardware of the memory unit 60 is remodeled, software processing also needs to be modified because of a change of access method or the like, lowering the convenience and the management efficiency.

### SUMMARY OF THE INVENTION

The present invention was created in view of the above circumstances, and an object thereof is to provide a program file management system which is capable of efficient management of a plurality of program files without using a dedicated unit for saving the program files, thereby reducing the scale of the system and improving convenience.

To achieve the object, there is provided a program file management system for managing a plurality of program files. The program file management system comprises a plurality of CPU units each including a memory having a starting area and a saving area as program file storage areas, and a CPU section for performing a switchover from the saving area to the starting area and performing an operation in accordance with a program file stored in the starting area, the CPU section being operative in response to a program file store instruction to transfer the program file under execution to the saving area of another CPU unit to be stored therein in accordance with table information, a table database for holding the table information, the table database including an address management table indicating start addresses of stored program files, and a destination CPU selection table indicating destination CPU units in which program files are to be saved, and an operation management section for performing interfacing of a command from a user and also performing a control process including downloading of program files to the CPU units, registration of the table information in the table database and issuance of the program file store instruction.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of a program file management system according to the present invention;

FIG. 2 is a diagram illustrating an address management table;

FIG. 3 is a diagram illustrating a destination CPU selection table;

FIGS. 4(A),(B) is a diagram illustrating the address management table and the destination CPU selection table;

FIG. 5 is a diagram also illustrating the address management table;

FIG. 6 is a diagram illustrating state transitions of program files;

FIG. 7 is a diagram also illustrating state transitions of the program files;

FIGS. 8(A),(B) is a diagram illustrating the address management table and the destination CPU selection table;

FIG. 9 is a diagram illustrating the address management table;

FIG. 10 is a flowchart illustrating an outline of operation;

FIG. 11 is a diagram illustrating commands specified by a user;

FIGS. 12(A), (B) is a diagram illustrating the address management table;

FIGS. 13(A),(B),(C),(D) is a diagram illustrating transitions of the destination CPU selection table in the process of creation;

FIG. 14 is a diagram illustrating state transitions of program files;

FIG. 15 is a diagram also illustrating state transitions of the program files;

FIG. 16 is a diagram illustrating state transitions of the program files;

FIG. 17 is a flowchart illustrating operation according to a third embodiment;

FIG. 18 is a diagram illustrating the destination CPU selection table;

FIGS. 19(A), (B) is a diagram illustrating the address management table;

FIG. 20 is a diagram illustrating an example of how table information is displayed;

FIG. 21 is a diagram illustrating state transitions of program files;

FIG. 22 is a diagram also illustrating state transitions of the program files;

FIG. 23 is a flowchart illustrating operation according to a sixth embodiment;

FIGS. 24(A), (B) is a diagram illustrating the address management table and the destination CPU selection table;

FIG. 25 is a diagram illustrating state transitions of program files;

FIG. 26 is a diagram also illustrating state transitions of the program files;

FIG. 27 is a diagram illustrating state transitions of the program files;

FIG. 28 is a diagram illustrating an exemplary configuration of a WDM system;

FIG. 29 is a diagram illustrating a configuration of a WDM node;

FIG. 30 is a diagram illustrating state transitions of program files; and

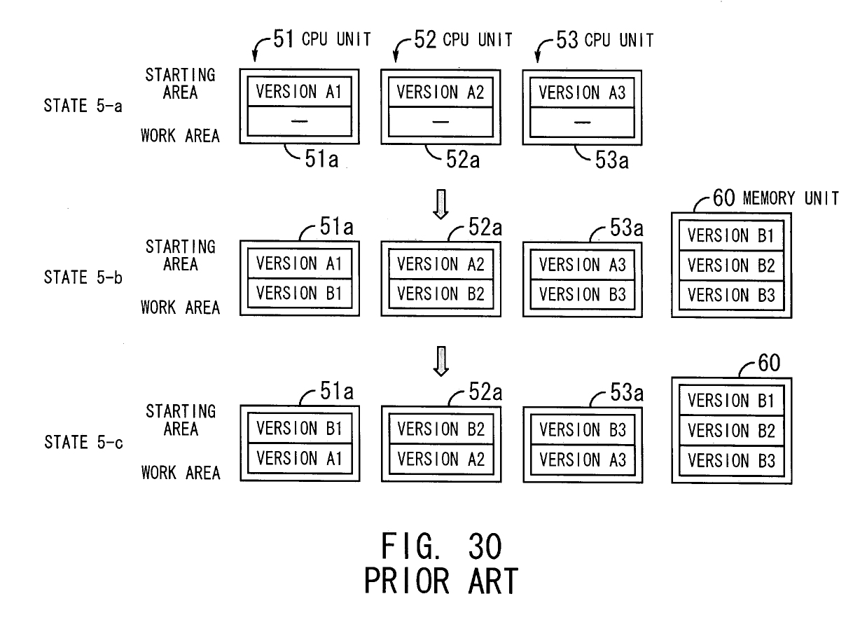

FIG. 31 is a diagram illustrating state transitions of program files at the time of restoration process.

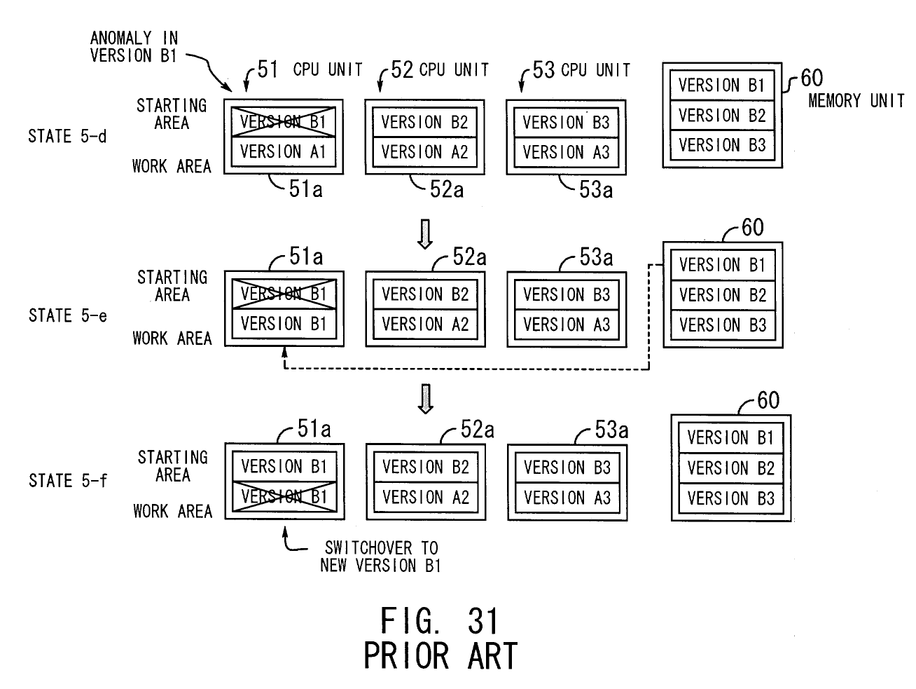

### DESCRIPTION OF THE PREFERRED EMBODIMENTS

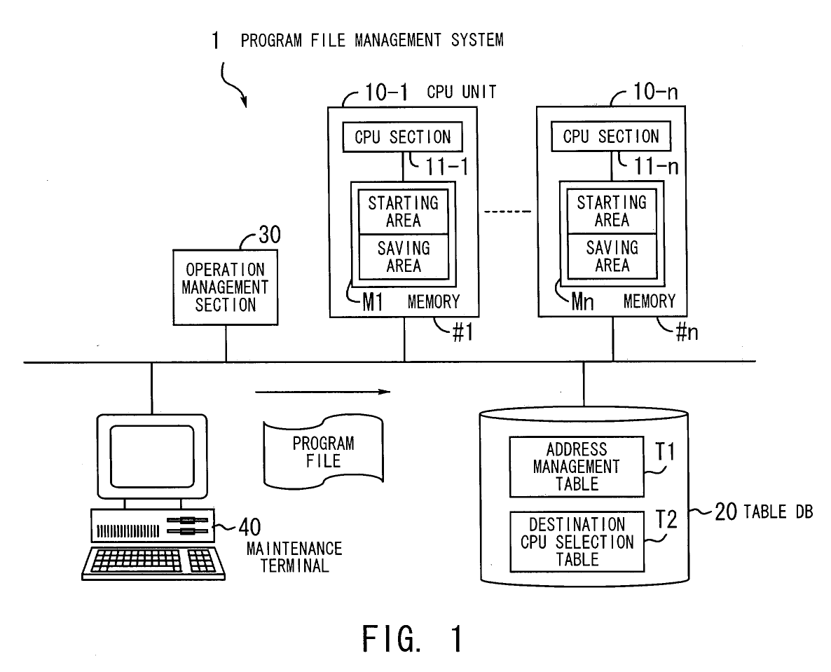

Embodiments of the present invention will be hereinafter described with reference to the drawings. FIG. 1 illustrates the principle of a program file management system according to the present invention. The program file management system 1 comprises a plurality of CPU units 10-1 to 10-n, a table database (hereinafter table DB) 20, and an operation management section 30.

The program file management system 1 of the present invention does not use a memory unit for exclusively storing program files, and uses instead backup space areas of memories M1 to Mn in the multiple CPU units 10-1 to 10-n to store and manage the program files.

The CPU units 10-1 to 10-n (referred to alternatively as CPU units #1 to #n) are card packages in which are packaged CPU sections 11-1 to 11-n and memories M1 to Mn for storing program files, respectively. The CPU units 10-1 to 10-n are generically referred to as CPU unit 10, the CPU sections 11-1 to 11-n as CPU section 11, and the memories M1 to Mn as memory M.

The memory M comprises a nonvolatile memory such as a flash memory, and has a starting area and a saving area as program file storage areas. The CPU section 11 performs a switchover from the saving area to the starting area (switchover can be performed from the saving area to the starting area and vice versa), and performs its own operation in accordance with the program file (starting program file) stored in the starting area.

The switchover from the saving area to the starting area referred to in the present invention does not mean physically switching data storage areas; the switchover is in practice accomplished by a switchover of read address from the starting area, from which data is currently read out, to the saving area, so that the program file as starting data is read out from the saving area.

In response to a program file store instruction from the operation management section 30, the CPU section 11 transfers the program file under execution to the saving area of the memory of another CPU unit to be stored therein, in accordance with table information in the table DB 20.

The CPU section 11 has supervisor control programs (including a BOOT program for starting, a service program for activating the program file in the memory M, etc.) for the control of monitoring and management of its own unit, and performs multitasking processing.

For example, the CPU section 11 performs a plurality of tasks, such as a task of communicating with the operation management section 30 or with another CPU unit, a task of switching the readout area of the memory M and performing an operation in accordance with the read program file, etc. in accordance with priority.

The table DB 20 has an address management table Ti and a destination CPU selection table T2, and holds and manages table information registered in these tables. The address management table T1 is a table indicating the start addresses of the stored program files. The destination CPU selection table T2 is a table indicating destination CPU units in which the program files are to be saved. The table DB 20 can be accessed as needed from the CPU unit 10 and the operation management section 30.

The operation management section 30 communicates with the user (maintenance technician) through a maintenance terminal 40, and controls management of the program files. For example, the operation management section performs interfacing of commands from the user, and notifies the maintenance terminal 40 of the operation state of the CPU unit 10 and the table information in the table DB 20.

Further, the operation management section 30 performs a control process including downloading of program files to the CPU unit 10, registration of the table information in the table DB 20, and issuance of the program file store instruction.

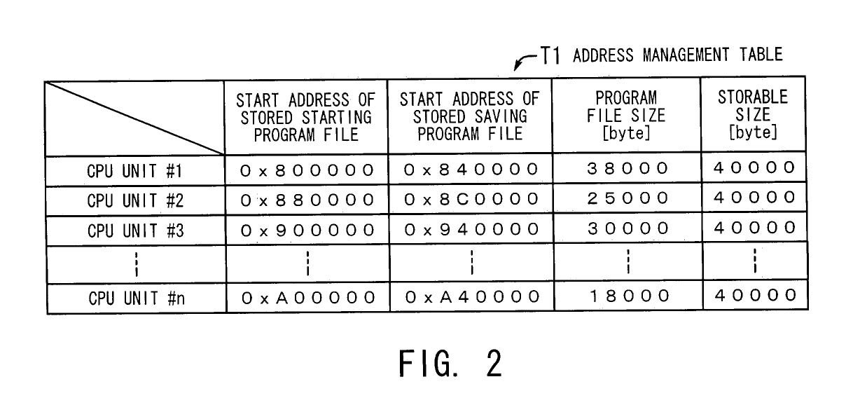

The address management table T1 and the destination CPU selection table T2 will be now described. FIG. 2 illustrates the address management table T1. The address management table T1 comprises, with respect to each of the memories M1 to Mn of the CPU units #1 to #n, fields indicating the start address of the stored starting program file, the start address of the stored saving program file, the program file size [byte], and the storable size [byte].

In the table shown in the figure, for the memory M1 of the CPU unit #1, for example, the start address of the starting area is 0x800000, the start address of the saving area is 0x840000, the program file size is 38,000 bytes, and the storable size of the saving area is 40,000 bytes.

The individual values of the table information in the address management table T1 are set by the user in advance before operation and are sent from the maintenance terminal 40 to the operation management section 30, which then registers the values in the address management table T1 of the table DB 20. During operation, the registered contents are modified as needed by the CPU unit 10.

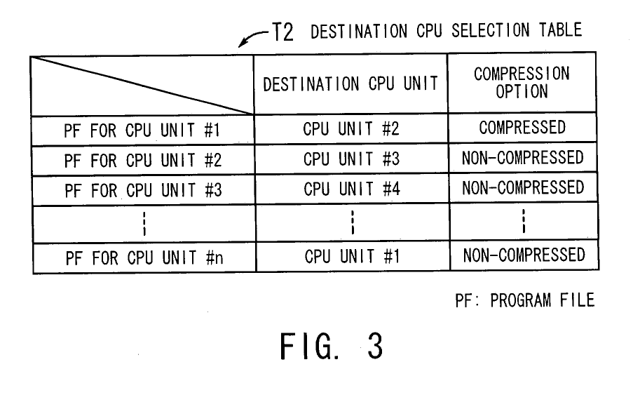

FIG. 3 illustrates the destination CPU selection table T2. The destination CPU selection table T2 comprises, with respect to the program file in each of the CPU units #1 to #n, fields indicating the CPU unit as a destination of saving, and the option as to compression.

The table shown in FIG. 3 indicates that the program file for the CPU unit #1, for example, should be compressed and saved in the CPU unit #2 (the saving area of the memory M2 of the CPU unit #2). Also, the table indicates that the program file for the CPU unit #2 should be saved in the CPU unit #3 without compression.

The individual values of the table information in the destination CPU selection table T2 are determined by the user in advance before operation. Specifically, the user determines whether each program file should be compressed or non-compressed, taking account of the storable size of the destination CPU unit, and sends the setting results from the maintenance terminal 40 to the operation management section 30, which then registers the setting information in the destination CPU selection table T2 of the table DB 20. The registered contents are not modified by the CPU unit 10 during operation (the settings registered first by the user remain unchanged).

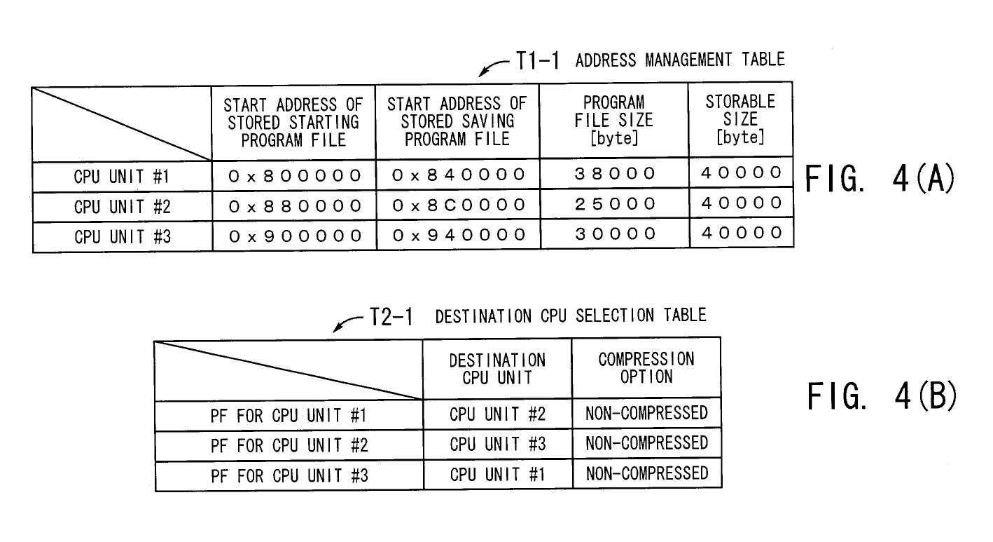

Basic operation of the program file management system 1 of a first embodiment, which is configured as explained above with reference to FIG. 1, will be now described with reference to FIGS. 4 to 7 in which are exemplified three CPU units #1 to #3.

FIGS. 4(A),(B) illustrates the address management table and the destination CPU selection table. The address management table T1-1 shown in the figure is in a state before a switchover from the saving area to the starting area.

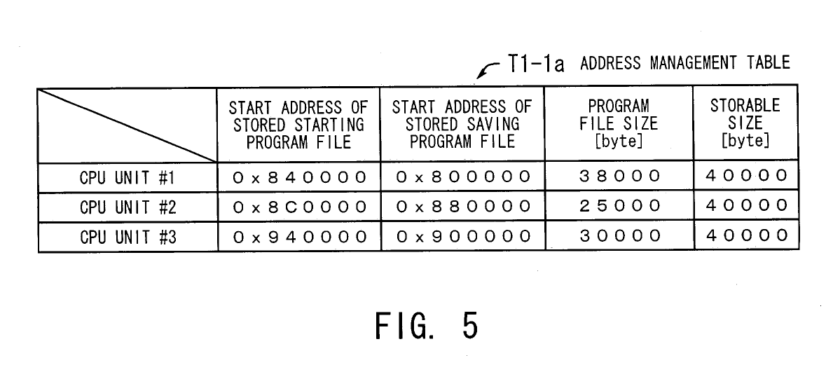

FIG. 5 also illustrates the address management table. The address management table T1-1a shown in the figure is in a state after the switchover from the saving area to the starting area. Namely, the illustrated table is a table generated following modification of the registered contents by the individual CPU units #1 to #3.

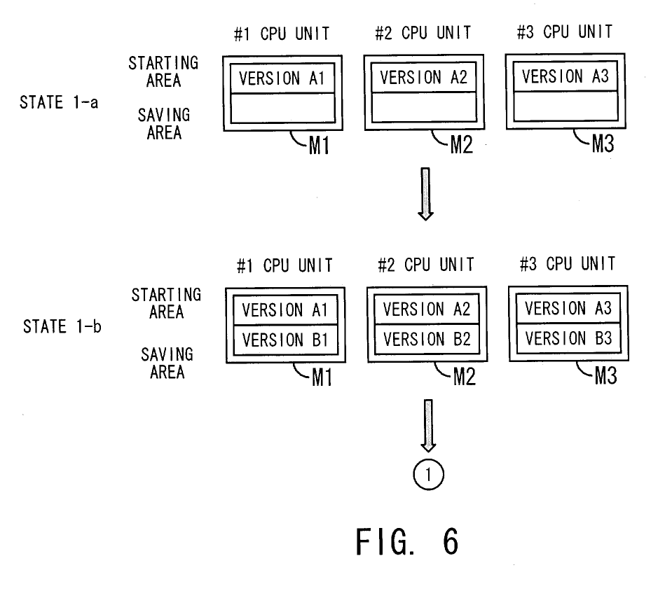

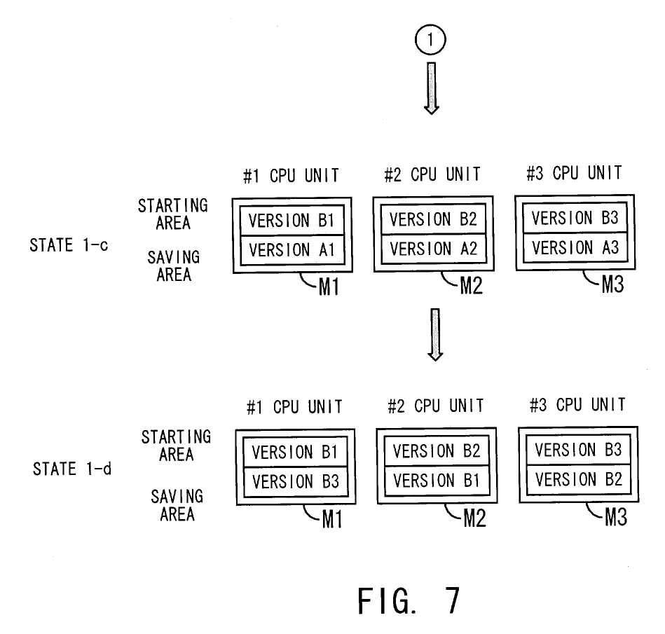

FIGS. 6 and 7 illustrate state transitions of program files.

[State 1-a] The CPU units are in a state before program files are downloaded to their saving areas. A program file (version A1) for the CPU unit #1 is stored in the starting area of the memory M1. Similarly, a program file (version A2) for the CPU unit #2 is stored in the starting area of the memory M2, and a program file (version A3) for the CPU unit #3 is stored in the starting area of the memory M3.

[State 1-b] The user collectively sends, to the operation management section 30 through the maintenance terminal 40, download commands to download program files (versions B1 to B3) to the CPU units #1 to #3.

On receiving the download commands from the user, the operation management section 30 accesses the address management table T1-1 to identify the start addresses for the respective saving program files, reads out the program files (versions B1 to B3) held by the maintenance terminal 40, and downloads (writes) the program files to the saving areas of the respective memories M1 to M3. The program files of versions B1 to B3 are associated respectively with the CPU units #1 to #3.

[State 1-c] The CPU sections 11-1 to 11-3 of the CPU units #1 to #3 communicate with each other, and after it is confirmed that the program files (versions B1 to B3) have been downloaded to the respective saving areas of all CPU units #1 to #3, the CPU sections 11-1 to 11-3 immediately perform a switchover between the starting and saving areas of the memories M1 to M3, and start the units by executing the program files of version B.

When switching the storage areas, the CPU sections 11-1 to 11-3 individually access the address management table T1-1 to change the values of the table information from those shown in the address management table T1-1 of FIG. 4 to those shown in the address management table T1-1a of FIG. 5 (the modification made is a transposition between the start address of the stored starting program file and the start address of the stored saving program file).

[State 1-d] On confirming that the switchover is completed in the CPU units #1 to #3, the operation management section 30 issues program file store instructions to the CPU units #1 to #3 so that the starting program files currently running and stored in the respective starting areas may be stored in the corresponding saving areas of the destination CPU units.

On receiving the program file store instruction, each of the CPU sections 11-1 to 11-3 of the CPU units #1 to #3 searches the destination CPU selection table T2-1 from the top row for the necessary table information, and stores the program file under execution in the corresponding program file saving area from the start address as specified by the address management table T1-1a (In each CPU unit, the operation according to the currently executed program file is performed in parallel with the process of transferring and storing the currently executed program file).

Specifically, the CPU section 11-1 transfers the program file (start address of starting area=0x840000; size=38,000 bytes) currently executed and stored in the starting area of the memory M1 to the saving area of the memory M2 of the CPU unit #2 to be stored from the start address 0x880000.

The CPU section 11-2 transfers the program file (start address of starting area=0x8C0000; size=25,000 bytes) currently executed and stored in the starting area of the memory M2 to the saving area of the memory M3 of the CPU unit #3 to be stored from the start address 0x900000.

The CPU section 11-3 transfers the program file (start address of starting area=0x940000; size=30,000 bytes) currently executed and stored in the starting area of the memory M3 to the saving area of the memory M1 of the CPU unit #1 to be stored from the start address 0x800000.

The process of storing the program file under execution in the saving area will be described in more detail. When actually starting a program file, the CPU section 11 once loads the program file from the memory M into a RAM (not shown) in the CPU unit, and starts the program file on the RAM. It is therefore possible to read the program file from the starting area and to store the same in the saving area (A program file may not necessarily be loaded into the RAM, and while the program file on a memory is under execution, the content thereof can be read from the memory and stored in another memory (but cannot be written into the same memory)).

As described above, according to the first embodiment, after the downloading is completed, the program files for the CPU units are transferred to and stored in one another's saving areas. It is therefore unnecessary to provide the system with a dedicated memory unit for backup, making it possible to reduce the scale of the system and improve the convenience and the management efficiency.

The reason why the program file for a CPU unit is stored in the saving area of another CPU unit and not in the saving area of its own will be explained. Let it be assumed that the program file for a CPU unit is stored in the saving area of its own memory.

In this case, if anomaly is found in the starting program file of the CPU unit, the program file read from its saving area also lacks reliability because the starting program file with respect to which anomaly has been detected is stored in the same memory. For this reason, according to the present invention, the program file for a CPU unit is transferred to and stored in another CPU unit.

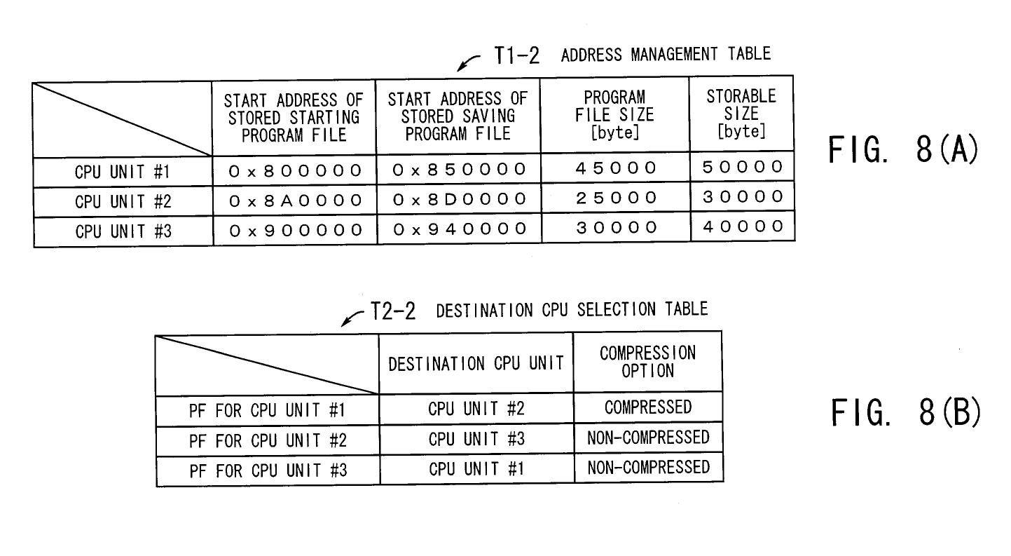

Operation according to a second embodiment will be now described. Compared with the first embodiment, the second embodiment additionally includes a compression process. FIGS. 8(A),(B) illustrates the address management table and the destination CPU selection table. The illustrated address management table T1-2 is in a state before the switchover of program files from the saving areas to the starting areas.

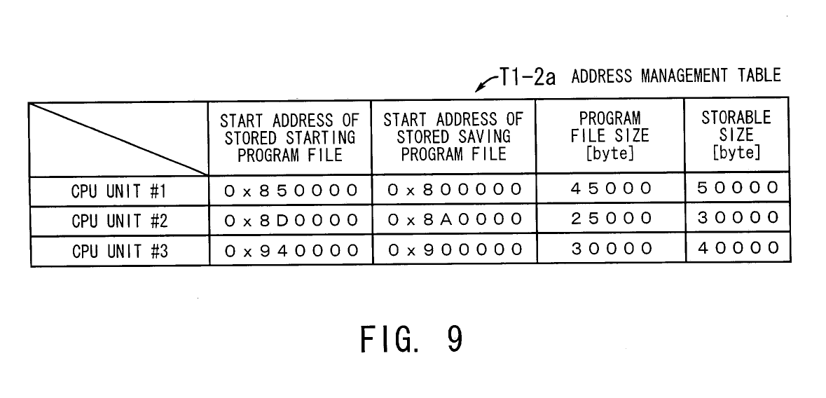

FIG. 9 illustrates the address management table T1-2a which is in a state after modification of registered contents as a result of the switchover of program files from the saving areas to the starting areas.

As seen from the address management table T1-2a, the program file size of the CPU unit #1 is 45,000 bytes, and the program file size of the CPU unit #2 is 25,000 bytes. Also, the destination CPU selection table T2-2 indicates that the program file for the CPU unit #1 should be compressed and saved in the CPU unit #2.

Accordingly, the CPU section 11-1 compresses the currently executed program file (start address of starting area=0x850000; size=45,000 bytes) stored in the starting area of the memory M1 from 45,000 bytes to 25,000 bytes, and transfers the compressed program file to the saving area of the memory M2 of the CPU unit #2 to be stored from the start address 0x8A0000.

As described above, according to the second embodiment, the program file to be backed up is compressed, whereby even if the saving area has a capacity smaller than the actual program file size, the program file can be stored.

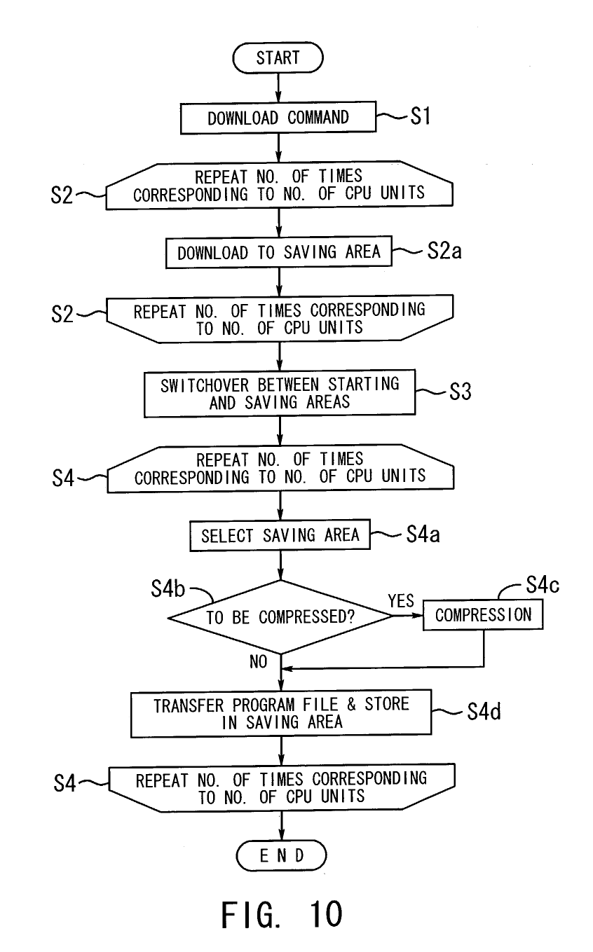

Operation according to the first and second embodiments will be now described with reference to the flowchart of FIG. 10 illustrating operation of the first and second embodiments.

[S1] The user transmits a download command.

[S2a] The operation management section 30 downloads a corresponding program file to the saving area of the CPU unit 10 (Step S2 is repeatedly executed a number of times corresponding to the number of CPU units).

[S3] The CPU unit 10 performs a switchover between the starting and saving areas, and starts the program file of new version.

[S4a] The CPU unit 10 looks up the address management table T1 and the destination CPU selection table T2, and selects the saving area in which the starting program file is to be stored.

[S4b] The CPU unit 10 determines whether or not compression is to be performed. If compression is required, the flow proceeds to Step S4c; if not, the flow proceeds to Step S4d.

[S4c] The CPU unit 10 compresses the program file.

[S4d] The CPU unit 10 transfers the program file and stores the same in the selected saving area (Step S4 is repeatedly executed a number of times corresponding to the number of CPU units).

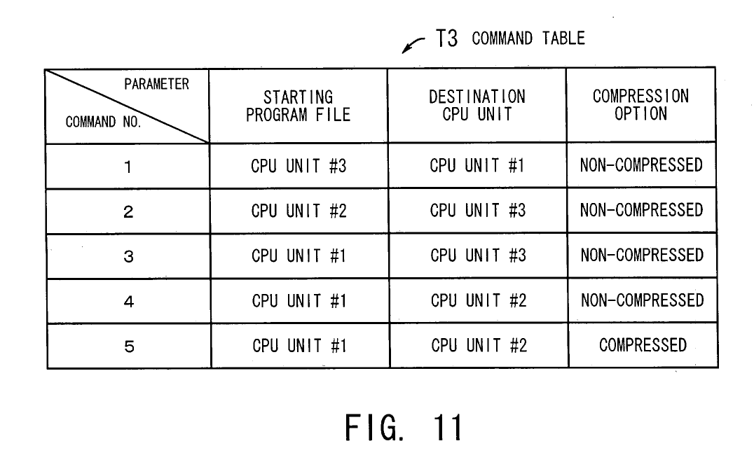

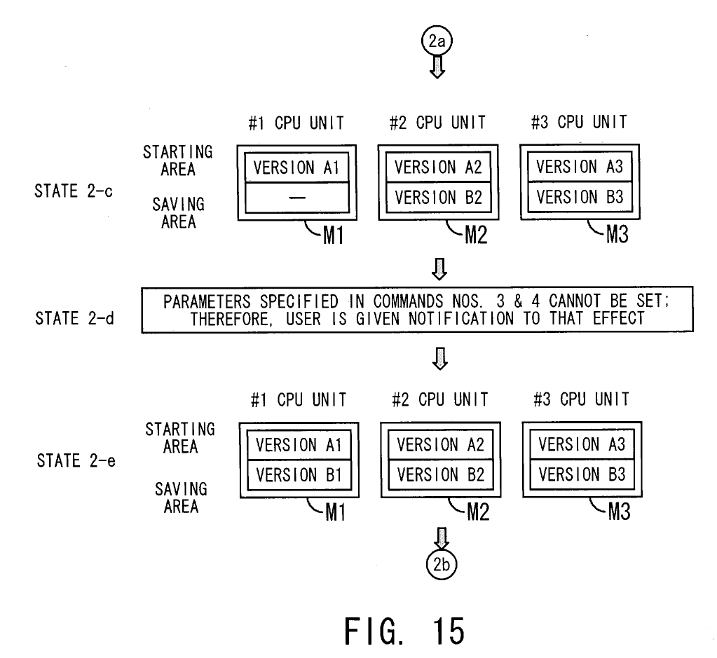

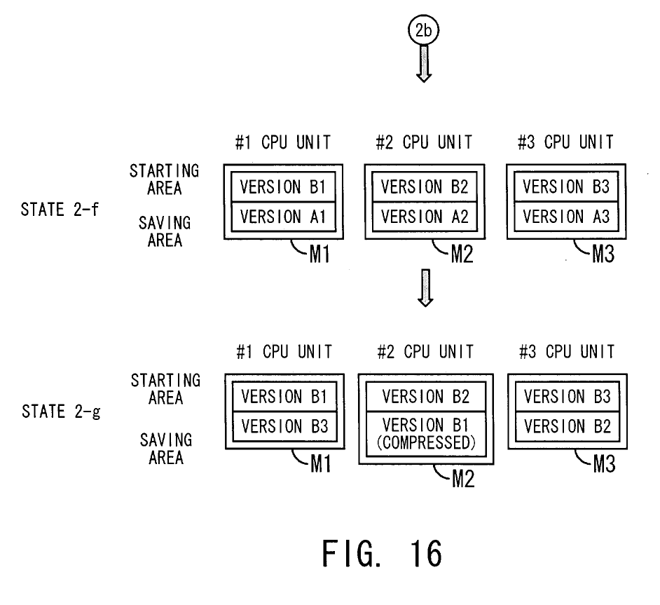

A third embodiment will be now described with reference to FIGS. 11 through 17. In the first embodiment, the destination CPU selection table T2 is generated at a time, but in the third embodiment, the destination CPU selection table T2 is sequentially generated based on the address management table T1 registered beforehand in the table DB 20 while the user and the operation management section 30 communicate with each other, and the switchover of storage areas is performed thereafter.

FIG. 11 illustrates commands specified by the user. In a command table T3, a command No. 1, for example, has parameters indicating that the starting program file of the CPU unit #3 should be saved in the CPU unit #1 without being compressed.

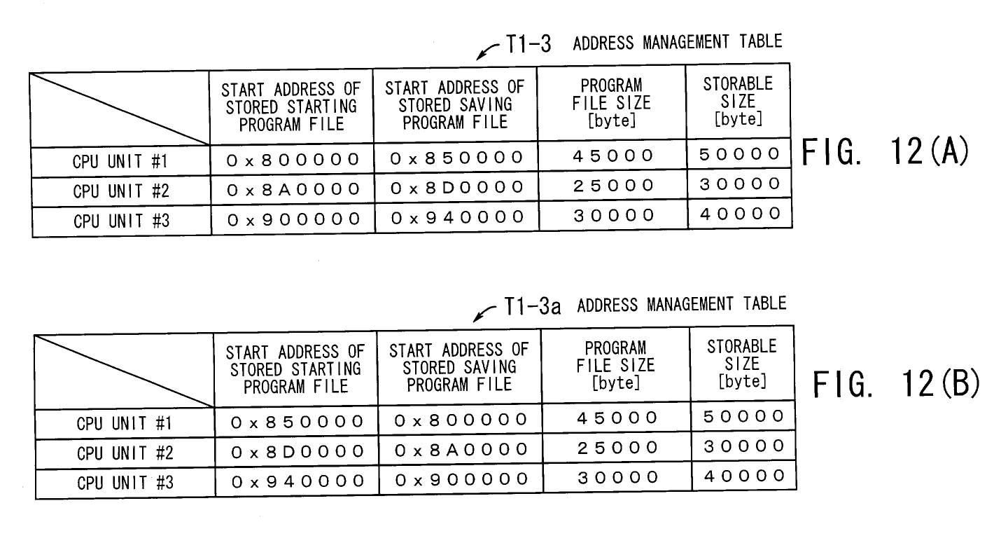

FIGS. 12(A),(B) illustrates the address management table, wherein an address management table T1-3 shows a state before the switchover of program files from the saving areas to the starting areas, and an address management table T1-3a shows a state after modification of the registered contents as a result of the switchover of program files from the saving areas to the starting areas.

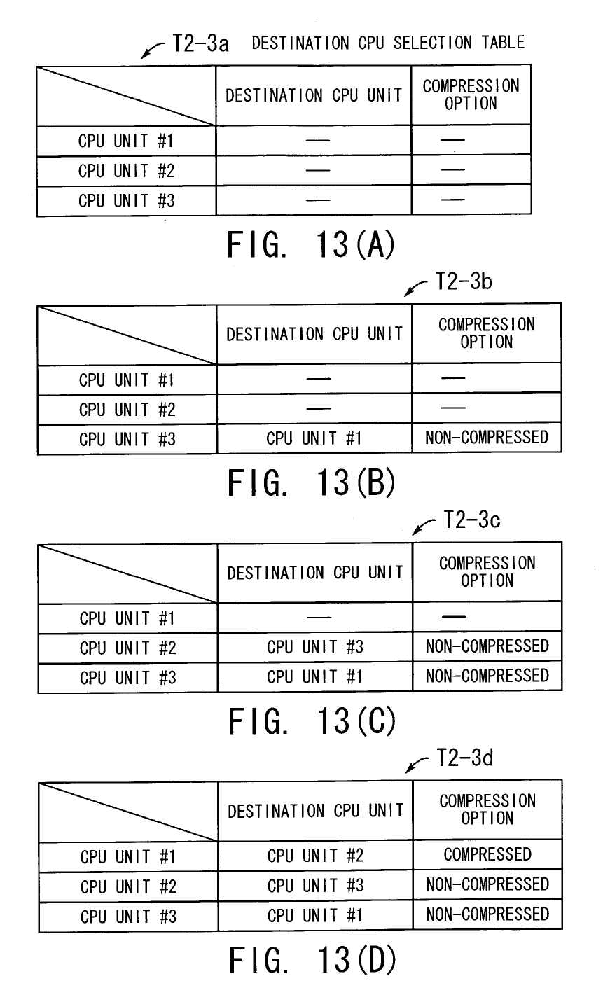

FIGS. 13(A), (B), (C), (D) illustrates transitions of the destination CPU selection table in the process of creation. Destination CPU selection tables T2-3a to T2-3d respectively show a state before downloading and states after table information is set for the CPU units #3, #2 and #1 in order.

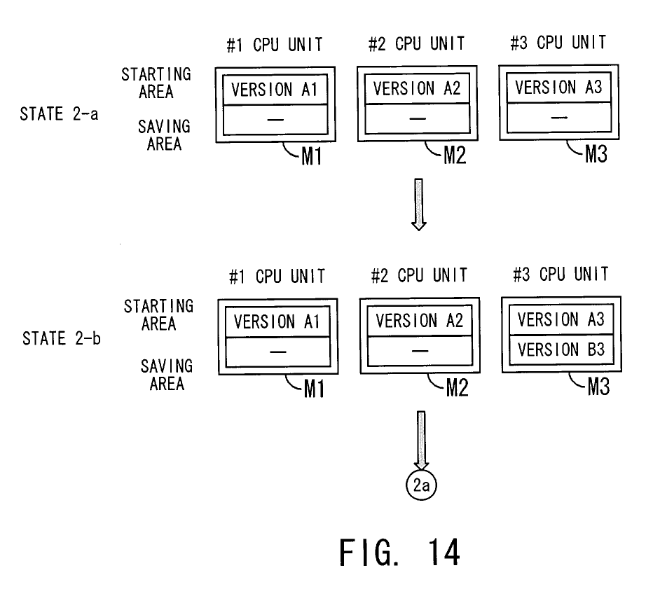

FIGS. 14 to 16 illustrate state transitions of program files.

[State 2-a] The illustrated state is a state before downloading of program files to the saving areas, and a program file (version A1) for the CPU unit #1 is stored in the starting area of the memory M1. Similarly, a program file (version A2) for the CPU unit #2 is stored in the starting area of the memory M2, and a program file (version A3) for the CPU unit #3 is stored in the starting area of the memory M3.

[State 2-b] The user transmits the command No. 1 shown in the command table T3 to the operation management section 30 through the maintenance terminal 40. The operation management section 30 determines based on the parameters included in the command No. 1 and the table information in the address management table T1-3 whether the command No. 1 can be set or not.

The command No. 1 requires that the starting program file of the CPU unit #3 should be stored in the CPU unit #1 without being compressed. Also, the address management table T1-3 shows that the starting program file of the CPU unit #3 has a size of 30,000 bytes while the storage size of the saving area of the CPU unit #1 is 50,000 bytes. Thus, the command No. 1 can be set.

Accordingly, the operation management section 30 registers table information, as shown in the destination CPU selection table T2-3b. Upon completion of the registration of the table information relating to the CPU unit #3, the operation management section 30 reads a program file (version B3) held by the maintenance terminal 40 and downloads the program file to the saving area of the memory M3 of the corresponding unit, that is, the CPU unit #3.

[State 2-c] The user transmits the command No. 2, shown in the command table T3, to the operation management section 30 through the maintenance terminal 40. The operation management section 30 determines based on the parameters included in the command No. 2 and the table information in the address management table T1-3 whether the command No. 2 can be set or not.

The command No. 2 requires that the starting program file of the CPU unit #2 should be stored in the CPU unit #3 without being compressed. Also, the address management table T1-3 shows that the starting program file of the CPU unit #2 has a size of 25,000 bytes while the storage size of the saving area of the CPU unit #3 is 40,000 bytes. Thus, the command No. 2 can be set.

Accordingly, the operation management section 30 registers table information, as shown in the destination CPU selection table T2-3c. Upon completion of the registration of the table information relating to the CPU unit #2, the operation management section 30 reads a program file (version B2) held by the maintenance terminal 40 and downloads the program file to the saving area of the memory M2 of the corresponding unit, that is, the CPU unit #2.

[State 2-d] The user transmits the command No. 3, shown in the command table T3, to the operation management section 30 through the maintenance terminal 40. Based on the parameters included in the command No. 3 and the table information in the address management table T1-3, the operation management section 30 determines whether or not the command No. 3 can be set.

The command No. 3 requires that the starting program file of the CPU unit #1 should be stored in the CPU unit #3 without being compressed. However, the destination CPU selection table T2-3c indicates that the saving area of the CPU unit #3 is already in use, and therefore, the command No. 3 cannot be set. Accordingly, the operation management section 30 sends a warning message that the parameters specified in the command No. 3 are invalid to the maintenance terminal 40 to give the user a notification to that effect.

The user further transmits the command No. 4, shown in the command table T3, to the operation management section 30 through the maintenance terminal 40. Based on the parameters included in the command No. 4 and the table information in the address management table T1-3, the operation management section 30 determines whether or not the command No. 4 can be set.

The command No. 4 requires that the starting program file of the CPU unit #1 should be stored in the CPU unit #2 without being compressed. However, the address management table T1-3 indicates that the starting program file of the CPU unit #1 has a size of 45,000 bytes while the storage size of the saving area of the CPU unit #2 is 25,000 bytes; therefore, the command No. 4 cannot be set. Accordingly, the operation management section 30 sends a warning message that the parameters specified in the command No. 4 are invalid to the maintenance terminal 40 to give the user a notification to that effect.

[State 2-e] The user transmits the command No. 5, shown in the command table T3, to the operation management section 30 through the maintenance terminal 40. The operation management section 30 determines based on the parameters included in the command No. 5 and the table information in the address management table T1-3 whether the command No. 5 can be set or not.

The command No. 5 requires that the starting program file of the CPU unit #1 should be stored in the CPU unit #2 while being compressed. The address management table T1-3 shows that the starting program file of the CPU unit #1 has a size of 45,000 bytes while the storage size of the saving area of the CPU unit #2 is 30,000 bytes, but since the program file is compressed, the command No. 5 can be set.

Accordingly, the operation management section 30 registers table information, as shown in the destination CPU selection table T2-3d. Upon completion of the registration of the table information relating to the CPU unit #1, the operation management section 30 reads a program file (version B1) held by the maintenance terminal 40 and downloads the program file to the saving area of the memory M1 of the corresponding unit, that is, the CPU unit #1.

[State 2-f] After the destination CPU selection table T2-3d is created according to the aforementioned procedure, the CPU sections 11-1 to 11-3 of the CPU units #1 to #3 communicate with each other. On confirming that the programs files (versions B1 to B3) have been stored in the respective saving areas of all CPU units #1 to #3, the CPU sections 11-1 to 11-3 immediately perform a switchover between the starting and saving areas of the memories M1 to M3, and then start the units with the use of the versions B.

At the time of the switchover of storage areas, the CPU sections 11-1 to 11-3 individually access the address management table T1-3 to change the values of the table information from those shown in the address management table T1-3 to those shown in the address management table T1-3a.

[State 2-g] On confirming that the switchover is completed in the CPU units #1 to #3, the operation management section 30 issues program file store instructions to the CPU units #1 to #3 to cause the starting program files to be stored in the saving areas of the respective destination CPU units.

On receiving the program file store instructions, the CPU sections 11-1 to 11-3 of the CPU units #1 to #3 look up the destination CPU selection table T2-3d to search for the table information from the top row, and transfer the respective program files under execution to the corresponding saving areas to be stored from the start addresses for saving program files specified by the address management table T1-3a.

Specifically, the CPU section 11-1 compresses the currently executed program file (start address of starting area=0x850000; size=45,000 bytes) stored in the starting area of the memory M1 from 45,000 bytes to 30,000 bytes, and transfers the program file to the saving area of the memory M2 of the CPU unit #2 to be stored from the start address 0x8A0000 of the saving area.

The CPU section 11-2 transfers the currently executed program file (start address of starting area=0x8D0000; size=25,000 bytes) stored in the starting area of the memory M2 to the saving area of the memory M3 of the CPU unit #3, and stores the program file from the start address 0x900000 of the saving area without compressing the program file.

Also, the CPU section 11-3 transfers the currently executed program file (start address of starting area=0x940000; size=30,000 bytes) stored in the starting area of the memory M3 to the saving area of the memory M1 of the CPU unit #1, and stores the program file from the start address 0x800000 of the saving area without compressing the program file.

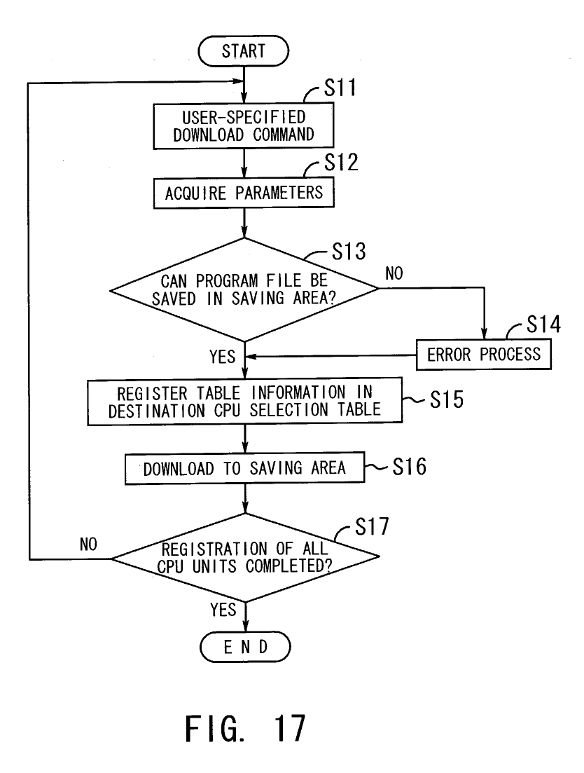

Operation according to the third embodiment will be now described with reference to the flowchart of FIG. 17 illustrating operation of the third embodiment.

[11] The user transmits a user-specified download command.

[S12] The operation management section 30 acquires the parameters set in the download command.

[S13] The operation management section 30 determines whether or not a corresponding program file can be saved in the saving area of the destination CPU unit. If the program file can be stored, the flow proceeds to Step S15; if not, the flow proceeds to Step S14.

[S14] The operation management section 30 sends a warning message to the user as an error process.

[S15] The operation management section 30 sets the table information in the destination CPU selection table T2.

[S16] The operation management section 30 downloads the corresponding program file to the saving area of the CPU unit.

[S17] The operation management section 30 confirms whether all CPU units have been registered or not. If all CPU units have been registered, the process is ended (the operation following the completion of registration in the destination CPU selection table T2 is identical with that explained above with reference to the first and second embodiments); if not, the flow returns to Step S11.

As described above, in the third embodiment, the destination CPU selection table can be sequentially created while the user and the operation management section 30 communicate with each other, and in the event a setting error is found, a warning message is issued, thus permitting highly reliable settings of program files.

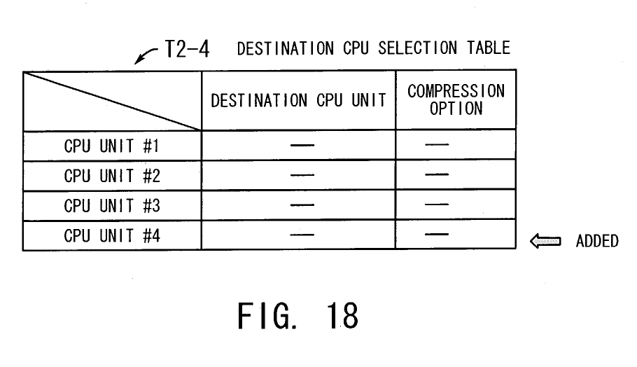

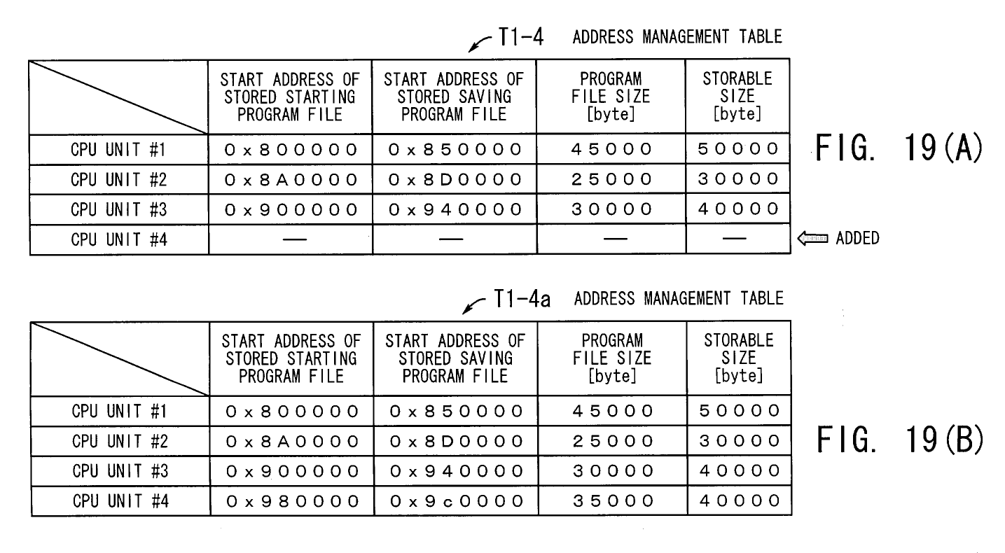

A fourth embodiment will be now described with reference to FIGS. 18 and 19. Compared with the first embodiment, the fourth embodiment is additionally provided with the function of updating the address management table T1 and the destination CPU selection table T2 in cases where a new CPU unit has been added.

FIG. 18 illustrates the destination CPU selection table. The user transmits an add command indicating the addition of a new CPU unit #4 to the operation management section 30 through the maintenance terminal 40.

On receiving the add command, the operation management section 30 deletes all previous information in the destination CPU selection table T2 and creates a destination CPU selection table T2-4 in which registration fields for the CPU unit #4 are reserved.

FIGS. 19(A),(B) illustrates the address management table. When the add command is received, the operation management section 30 secures registrations fields for the CPU unit #4 in the address management table T1 (address management table T1-4) with the previous information left as it is, and then sets the parameters included in the add command (address management table T1-4a).

Subsequently, in accordance with the command table T3 explained above in relation to the third embodiment, table information is registered in the destination CPU selection table T2-3a and then the switchover of storage areas is performed.

As described above, according to the fourth embodiment, when a CPU unit is added, the address management table T1 and the destination CPU selection table T2 are automatically reconstructed, thus enabling efficient and flexible management of program files.

A fifth embodiment will be now described. Compared with the first embodiment, the fifth embodiment has an additional function of display control for displaying the table information in the address management table T1 and destination CPU selection table T2 at the maintenance terminal 40.

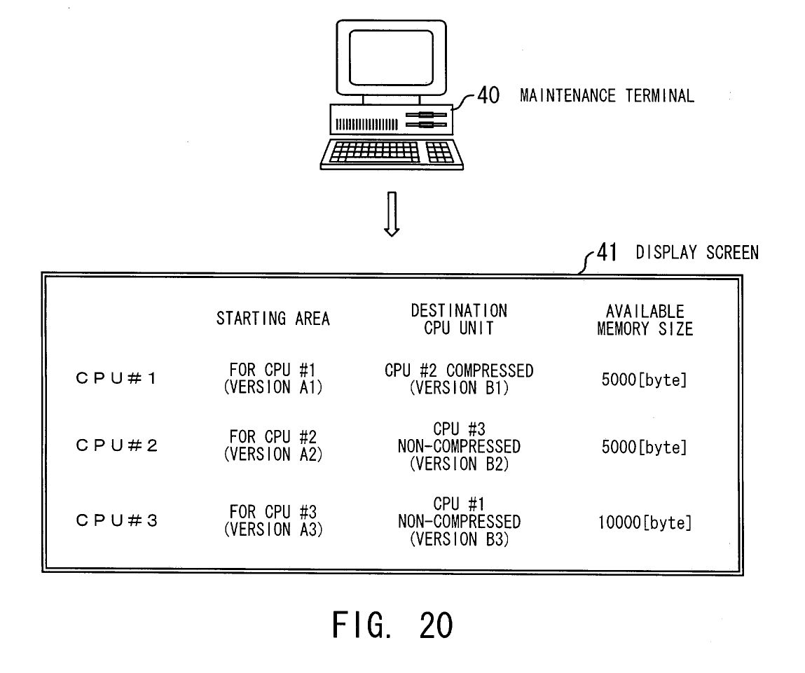

FIG. 20 illustrates an example of how the table information is displayed. The operation management section 30 looks up the address management table T1 and destination CPU selection table T2 in the table DB 20 and controls the maintenance terminal 40 to display the table information. In the illustrated example, the contents of the address management table T1-2 and destination CPU selection table T2-2 shown in FIG. 8 are displayed.

Under the starting area in a display screen 41, the versions of the program files stored in the respective CPU units are displayed (At this stage, the switchover between the starting and saving areas is not performed yet, and therefore, the versions A are stored in the starting areas).

For the destination CPU unit, data (including information about compression/non-compression and version) specified in the destination CPU selection table T2-2 is displayed (nothing is displayed if no data is set). Also, for the available memory size, memory sizes (free memory sizes) obtained by subtracting the program file sizes from the respective storable sizes set in the address management table T1-2 are displayed.

As described above, in the fifth embodiment, the table information in the address management table T1 and destination CPU selection table T2 is displayed at the maintenance terminal 40, whereby the convenience of maintenance and management can be enhanced.

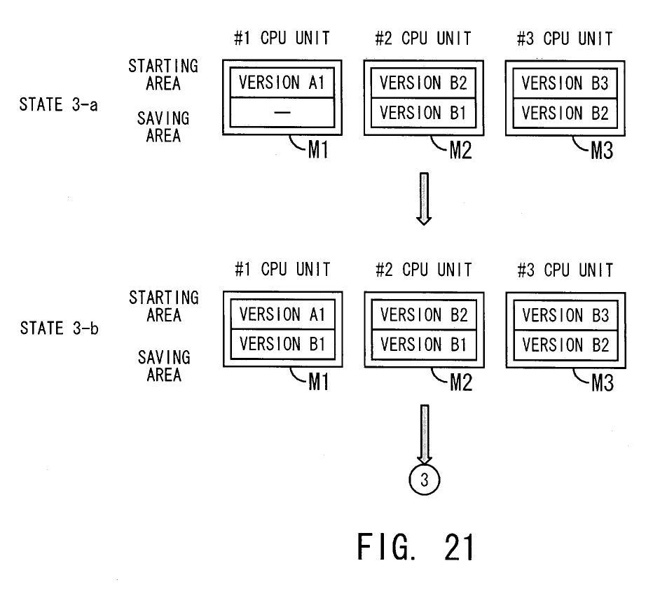

A sixth embodiment will be now described with reference to FIGS. 21 to 23. Compared with the first embodiment, the sixth embodiment is additionally provided with a restoration function whereby, in cases where anomaly has occurred in part of the program file (including the case where the version of the program file has been changed because of, e.g., manual replacement of CPU units), the program file of the corresponding CPU unit is switched to a normal one.

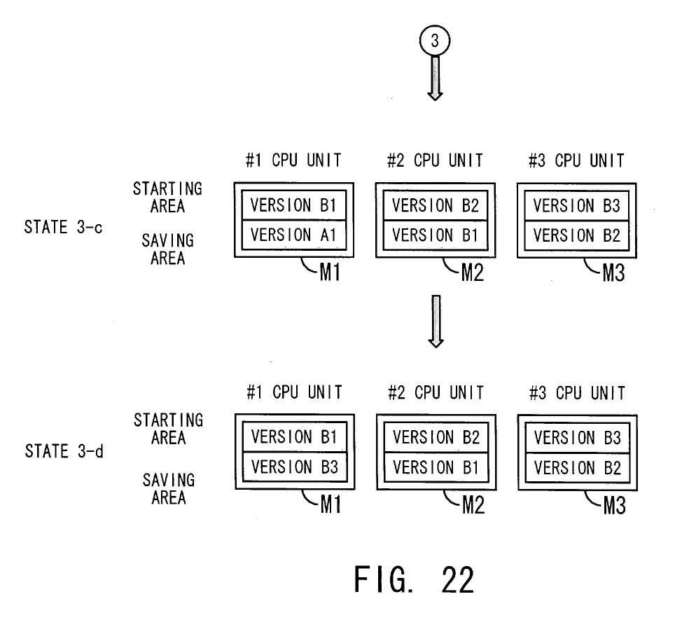

FIGS. 21 and 22 illustrate state transitions of program files. The following explains a restoration process for restoring the version of a program file to a normal version, for example, in the case of the address management table T1-1, T1-1a and destination CPU selection table T2-1 shown in FIGS. 4 and 5.

[State 3-a] The memory M3 has its own program file (version B3) stored in the starting area, and has a program file (version B2) for the CPU unit #2 stored in the saving area.

Also, the memory M2 has its own program file (version B2) stored in the starting area, and has a program file (version B1) for the CPU unit #1 stored in the saving area.

On the other hand, the starting area of the memory M1 has a program file of version A stored therein, while the saving area has nothing stored therein. The CPU sections 11-1 to 11-3 communicate with each other, and as a result, the CPU section 11-1 recognizes that the version of the program file of its own unit differs from that of the program files in the other units.

[State 3-b] The CPU section 11-1 looks up the destination CPU selection table T2-1 to determine which CPU unit has a normal program file for the CPU unit #1 stored in the saving area thereof. In this example, it is found that the program file for the CPU unit #1 is saved in the CPU unit #2. Accordingly, the CPU section 11-1 reads out the program file (version B1) from the saving area of the memory M2 of the CPU unit #2 and transfers the program file to the saving area of its own memory M1 to be written therein.

If, in this case, the program file (version B1) stored in the saving area of the memory M2 of the CPU unit #2 is compressed, the CPU section 11-1 transfers the program file (version B1) while decompressing the same, to be written into the saving area of the memory M1 (The CPU section does not store a compressed program file directly in the saving area of the memory M1 of its own unit, because immediately after the switchover between the starting and saving areas, the program file needs to be started without delay).

[State 3-c] On completion of the writing of the transferred program file in the saving area, the CPU section 11-1 performs a switchover between the starting and saving areas, and starts the program file of version B1.

[State 3-d] The CPU section 11-1 looks up the destination CPU selection table T2-1 to determine which CPU unit holds a program file that is to be stored in the saving area of its own memory M1. In this example, it is found that the program file of the CPU unit #3 should be stored.

Thereupon, the CPU section 11-1 reads out the currently executed program file (start address of starting area=0x940000; size=30,000 bytes) stored in the starting area of the memory M3, and transfers the program file to the saving area of the memory M1 to be stored from the start address 0x800000 (in this example, no compression is needed, but the program file is stored after being compressed, if required).

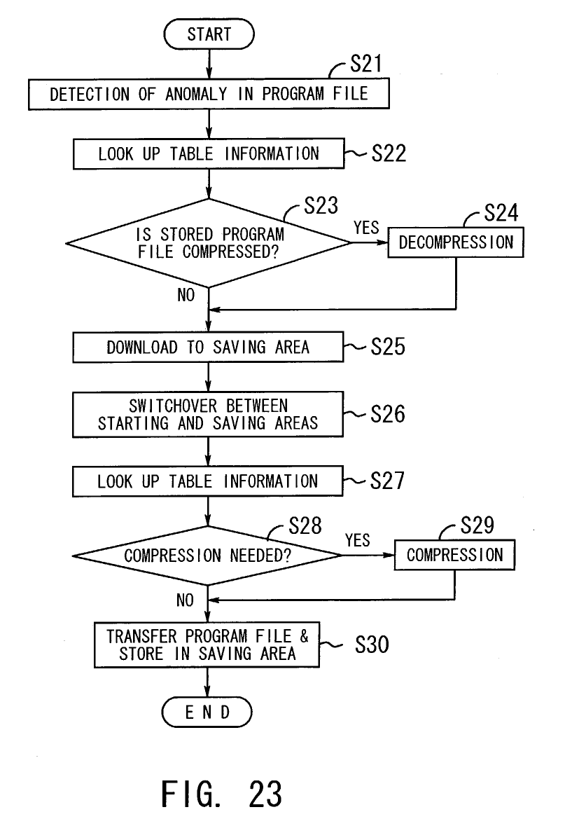

Operation according to the sixth embodiment will be now described with reference to the flowchart of FIG. 23 illustrating operation of the sixth embodiment.

[S21] Anomaly in a program file is detected by the CPU unit 10.

[S22] The CPU unit 10 looks up the destination CPU selection table T2 to identify the location where a normal program file therefor is stored.

[S23] The CPU unit 10 determines whether or not the stored program file is compressed. If the program file is compressed, the flow proceeds to Step S24; if not, the flow proceeds to Step S25.

[S24] The CPU unit 10 decompresses the program file.

a[S25] The CPU unit 10 downloads the program file to the saving area.

[S26] The CPU unit 10 performs a switchover between the starting and saving areas, and starts the normal program file.

[S27] The CPU unit 10 looks up the address management table T1 and the destination CPU selection table T2, to select the saving area in which the starting program file is to be stored.

[S28] The CPU unit 10 determines whether or not compression is needed. If compression is needed, the flow proceeds to Step S29; if not, the flow proceeds to Step S30.

[S29] The CPU unit 10 compresses the program file.

[S30] The CPU unit 10 transfers the program file to the selected saving area and stores the same therein.

As described above, according to the sixth embodiment of the present invention, in cases where there is an anomaly in a program file, a program file stored in another CPU unit is utilized to quickly replace the anomalous program file with a normal one, whereby the quality of program file management can be improved.

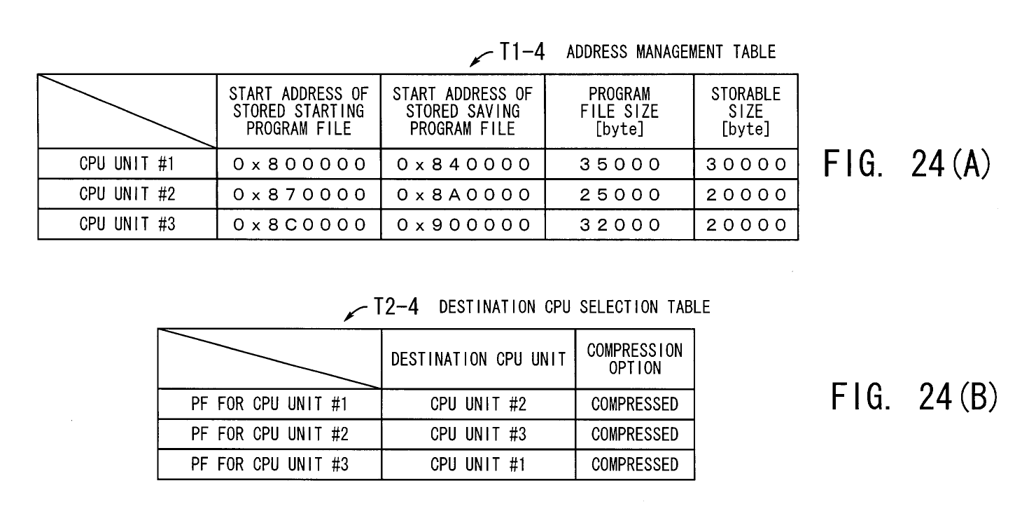

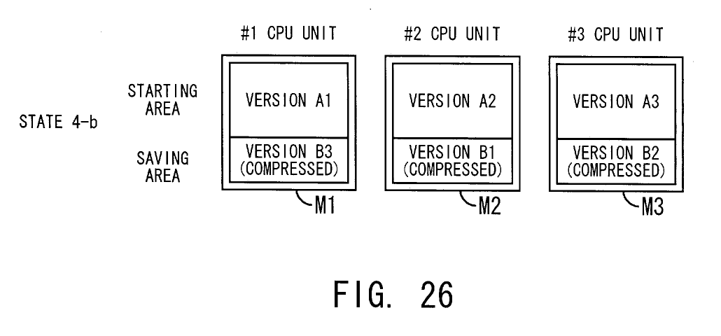

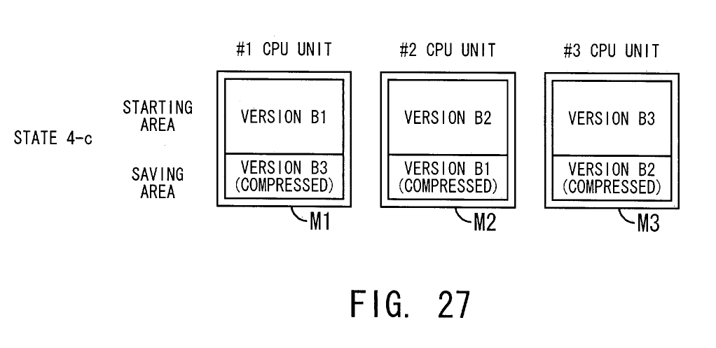

A seventh embodiment will be now described with reference to FIGS. 24 to 27. In the first through sixth embodiments, the memory M used is configured such that the saving area has a capacity equal to or larger than that of the starting area. The seventh embodiment provides operation control applied in cases where the capacity of the saving area is smaller than that of the starting area.

FIGS. 24(A),(B) illustrates the address management table and the destination CPU selection table. The address management table T1-4 and destination CPU selection table T2-4 shown in the figure indicate that all of the program files for the CPU units #1 to #3 are greater in size than the storable sizes of the destination CPU units and thus need to be compressed when stored.

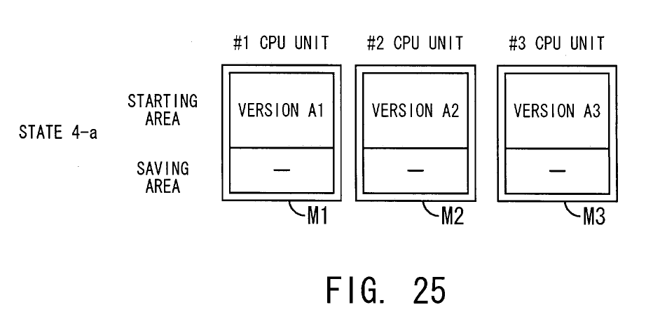

FIGS. 25 to 27 illustrate state transitions of program files.

[State 4-a] Program files of versions A1 to A3 are stored in the memories M1 to M3 of the respective CPU units #1 to #3 and are executed.

[State 4-b] The user collectively transmits download commands to the operation management section 30 through the maintenance terminal 40 to download program files (versions B1 to B3) to the CPU units #1 to #3.

The download commands transmitted in this case are different from the download commands to download program files (versions B1 to B3) for the respective CPU units #1 to #3 to the corresponding saving areas, and are download commands to transfer program files to the saving areas of other units to be stored therein (the commands are similar in content to the program file store instructions).

On receiving the download commands from the user, the operation management section 30 looks up the address management table T1-4 and the destination CPU selection table T2-4. Subsequently, the program file (version B3) for the CPU unit #3 is compressed and stored in the saving area of the memory M1 of the CPU unit #1, the program file (version B1) for the CPU unit #1 is compressed and stored in the saving area of the memory M2 of the CPU unit #2, and the program file (version B2) for the CPU unit #2 is compressed and stored in the saving area of the memory M3 of the CPU unit #3.

[State 4-c] The CPU sections 11-1 to 11-3 of the CPU units #1 to #3 communicate with each other, and on confirming that all CPU units #1 to #3 have the respective program files (versions B1 to B3) stored in their saving areas, the CPU sections 11-1 to 11-3 stop their operations according to the currently executed program files of versions A1 to A3.

Then, the CPU section 11-1 looks up the destination CPU selection table T2-4. On recognizing that the program file of version B1 is stored in the CPU unit #2 while being compressed, the CPU section 11-1 transfers the program file (version B1) to the starting area of its own memory M1, while decompressing the same, and writes the program file therein.

Similarly, the CPU section 11-2 looks up the destination CPU selection table T2-4. On recognizing that the program file of version B2 is stored in the CPU unit #3 while being compressed, the CPU section 11-2 transfers the program file (version B2) to the starting area of its own memory M2, while decompressing the same, and writes the program file therein.

The CPU section 11-3 also looks up the destination CPU selection table T2-4. On recognizing that the program file of version B3 is stored in the CPU unit #1 while being compressed, the CPU section 11-3 transfers the program file (version B3) to the starting area of its own memory M3, while decompressing the same, and writes the program file therein.

The CPU sections 11-1 to 11-3 of the CPU units #1 to #3 communicate with each other, and on confirming that all CPU units #1 to #3 have the respective program files (versions B1 to B3) stored in their starting areas, start the respective program files (versions B1 to B3).

As described above, in the seventh embodiment, when the switchover between the starting and saving areas is performed in cases where the capacity of the saving area is smaller than that of the starting area, the operation according to the starting program file is once stopped, and the compressed program file stored in the saving area is transferred to and stored in the starting area while being decompressed.

Thus, even in the case where the available capacities are not large enough to save program files, it is possible to store, in the saving areas, program files for other CPU units and to perform the switchover of storage areas.

As explained above, the program file management system 1 of the present invention is constructed such that each memory has a starting area and a saving area as program file storage areas and that the program file under execution is stored in the saving area of another CPU unit.

This makes it unnecessary to use a memory unit for exclusively saving program files. Even in cases where a memory unit is used, it is unnecessary to remodel the hardware to increase the memory capacity when the capacity of the memory unit runs short, whereby the scale of the system can be reduced and the convenience improved, making it possible to construct a high-reliability downloading system.

In the foregoing description, the operation management section 30 and the CPU units 10 are explained as independent units, but one of the multiple CPU units 10 may be configured to perform the function of the operation management section 30.

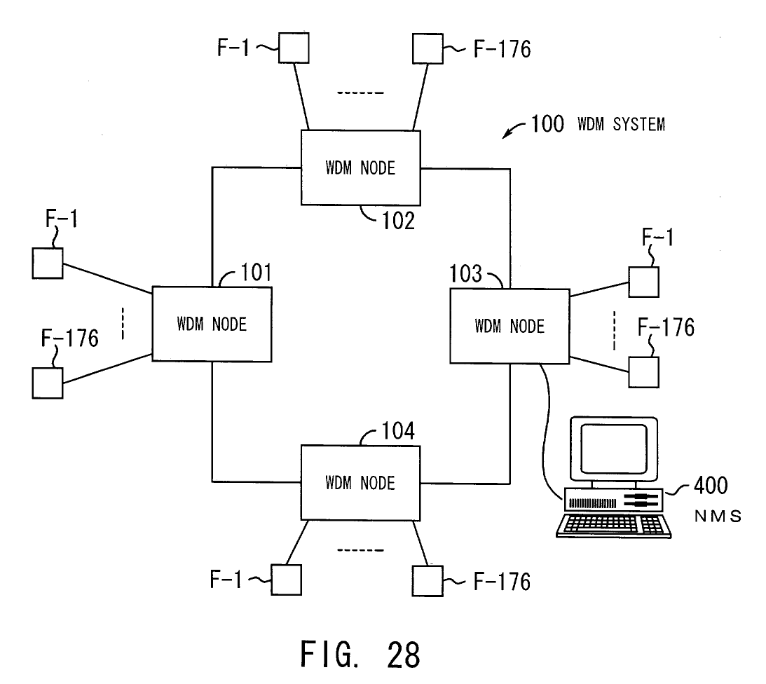

The following describes the case where the program file management system 1 is applied to a WDM system for performing WDM communication. FIG. 28 illustrates an exemplary configuration of such a WDM system. The WDM system 100 has WDM nodes 101 to 104 interconnected in ring form to constitute a ring network.

Each of the WDM nodes 101 to 104 is connected with transmission devices F-1 to F-176 for performing SONET/SDH transmission control, and accommodates 176 optical fiber cables extending from the transmission devices F (one optical fiber cable has a transmission capacity of 10 Gb/s).

On the downstream side of the transmission devices F-1 to F-176 are connected exchanges, routers, mobile terminals, etc., though not shown. Also, as shown in the figure, an NMS (Network Management System) 400 for network management of the WDM system 100 is connected to the WDM node 103 to monitor and manage the whole system. The NMS 400 corresponds to the maintenance terminal 40.

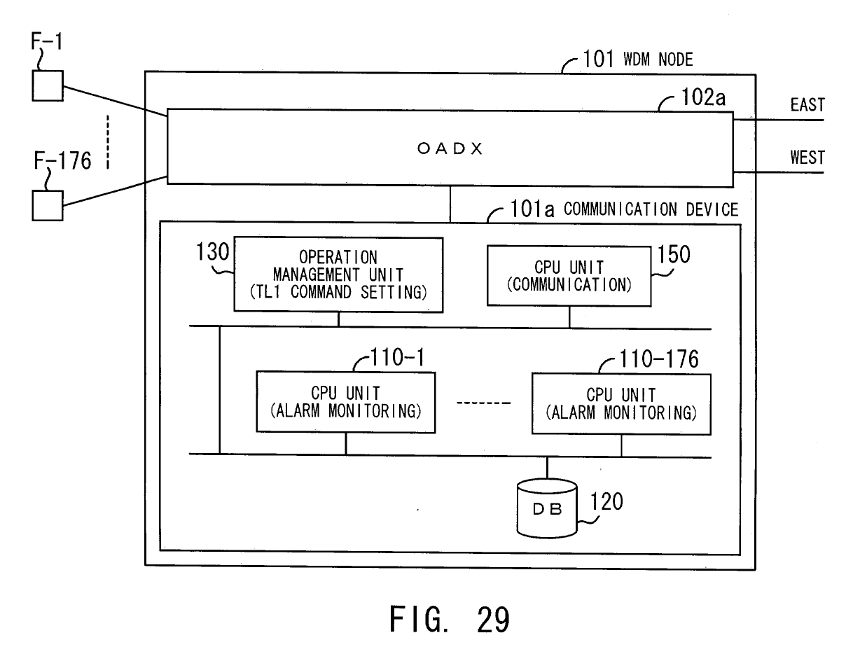

FIG. 29 illustrates the configuration of the WDM node. The WDM node 101 (of which the configuration is identical with that of the WDM nodes 102 to 104) includes a communication device 101a and an OADX (optical add/drop cross-connect) 102a. The communication device 101a has CPU units 110-1 to 110-176 as subordinate CPU units, an operation management unit 130 and a CPU unit 150 as host CPU units, and a DB 120.

The CPU units 110-1 to 110-176 and 150 correspond to the CPU units 10-1 to 10-n, the operation management unit 130 corresponds to the operation management section 30, and the DB 120 corresponds to the table DB 20.

Operation will be now described. In order to change paths, the OADX 102a subjects optical signals transmitted from the transmission devices F-1 to F-176 to optical cross-connect control (optical switching) for every wavelength, to thereby ADD channels (multiplex the signals), and outputs the multiplexed signal to the EAST or WEST side of the ring network. An optical signal received from the ring network side is also subjected to the optical cross-connect control, to thereby DROP channels (demultiplex the signal), and the demultiplexed signal is output to a corresponding one of the transmission devices F-1 to F-176.

The CPU unit 150 of the communication device 101a controls communication (mediation) between the OADX 102a and the communication device 101a. The operation management unit 130 communicates with the NMS 400 to manage the communication device 101a. Also, the unit 130 is capable of setting TL1 (Transaction Language 1) commands (TL1 is language specification prescribed by North America GR standards).

The number of the CPU units 110-1 to 110-176 provided corresponds to the number of channels of the transmission devices F to be connected. Like the CPU units 10-1 to 10-n of the foregoing embodiments of the present invention, these CPU units each have a memory (not shown) for storing program files, perform a switchover from the saving area to the starting area, and execute operation in accordance with the program file stored in the starting area.

Also, in response to an instruction from the operation management unit 130, each CPU unit transfers the program file under execution to the saving area of another unit to be stored therein in accordance with the table information stored in the DB 120. Specific operations executed by the CPU units 110-1 to 110-176 include, for example, monitoring of alarms on the respective channels.

As explained above, by applying the program file management system 1 of the present invention to a WDM node which is large in scale, it is possible to efficiently manage program files of the CPU units 110-1 to 110-176, 130 and 150 on a real-time basis.

Also, even in cases where the wavelength multiplicity is increased afterward to develop a system capable of transmission at rates of the order of several terabits, enlargement in scale of the system can be minimized by applying the present invention, making it possible to develop a low-cost, high-quality photonic network system.

In the foregoing description, the present invention is applied to WDM network, but the application of the present invention is not limited to WDM network alone and the invention can be applied to a wide range of communication systems (e.g., a communication system for processing IP packets or TDM signals with the use of a plurality of CPU units).

As described above, the program file management system according to the present invention is constructed such that each memory has a starting area and a saving area as program file storage areas and that the program file under execution is stored in the saving area of another CPU unit. This makes it possible to efficiently manage a plurality of program files without using a dedicated unit for saving the program files, thus permitting reduction in scale of the system and improvement in the convenience and management efficiency.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A program file management system for managing a plurality of program files, comprising:
a plurality of CPU units each including a memory having a starting area and a saving area as program file storage areas, and a CPU section for performing a switchover from the saving area to the starting area and performing an operation in accordance with a program file stored in the starting area, the CPU section being operative in response to a program file store instruction to transfer the program file under execution to the saving area of another CPU unit to be stored therein in accordance with table information;
a table database for holding the table information, said table database including an address management table indicating start addresses of stored program files, and a destination CPU selection table indicating destination CPU units in which program files are to be saved; and
an operation management section for performing interfacing of a command from a user and also performing a control process including downloading of program files to said CPU units, registration of the table information in said table database and issuance of the program file store instruction.

2. The program file management system according to claim 1, wherein said CPU section has a compression/decompression function, and if the saving area has a capacity smaller than size of a program file, said CPU section compresses the program file and then stores the compressed program file in the saving area.

3. The program file management system according to claim 1, wherein said operation management section receives a command transmitted from the user and including parameters indicative of a source CPU unit storing a starting program file, a destination CPU unit and information about compression/non-compression option, and sequentially creates the destination CPU selection table.

4. The program file management system according to claim 3, wherein said operation management section determines based on the parameters of the command and the table information in the address management table whether the command can be set or not, and issues a warning message if the command cannot be set.

5. The program file management system according to claim 1, wherein said operation management section is operative in response to addition of a new CPU unit to add a new registration field to the address management table with previous information left as it is, and to clear all previous information in the destination CPU selection table and then add a new registration field thereto, to thereby automatically reconstruct the address management table and the destination CPU selection table.

6. The program file management system according to claim 1, wherein said operation management section controls display of the table information in the address management table and the destination CPU selection table.

7. The program file management system according to claim 1, wherein, on detection of anomaly in the starting program file, said CPU section looks up the destination CPU selection table to determine which CPU unit has a normal program file stored in the saving area thereof, reads out the normal program file, transfers the normal program file to the saving area of its own memory to be written into the saving area, performs the switchover between the starting and saving areas, and then starts by executing the normal program file.

8. The program file management system according to claim 1, wherein, if the saving area of the memory has a capacity smaller than that of the starting area, said CPU section transfers a compressed program file stored in the saving area to the starting area to be stored therein by first stopping an operation in accordance with the program file under execution and then transferring the compressed program file to the starting area, while decompressing the program file, to be written into the starting area.

9. A CPU unit for performing control by means of a CPU, comprising:
a memory having a starting area and a saving area as program file storage areas; and
a CPU section for performing a switchover from the saving area to the starting area and performing an operation in accordance with a program file stored in the starting area, said CPU section being operative in response to a program file store instruction to transfer the program file under execution to the saving area of another CPU unit to be stored therein in accordance with table information.

10. An operation management device for controlling a CPU unit,
wherein said operation management device performs interfacing of a command from a user and also performs a control process including downloading of program files to the CPU unit, registration of table information in a table database and issuance of a program file store instruction.

11. A program file management method for managing a plurality of program files, comprising:
performing, with respect to a plurality of CPU units each including a memory having a starting area and a saving area as program file storage areas, a switchover from the saving area to the starting area, to execute an operation in accordance with a program file stored in the starting area; and
transferring, in response to a program file store instruction and in accordance with table information in an address management table indicating start addresses of stored program files and a destination CPU selection table indicating destination CPU units in which program files are to be saved, the program file under execution to the saving area of another CPU unit to be stored therein.

12. The program file management method according to claim 11, wherein, if the saving area has a capacity smaller than size of a program file, the program file is compressed and then stored in the saving area.

13. The program file management method according to claim 11, further comprising receiving a command transmitted from a user and including parameters indicative of a source CPU unit storing a starting program file, a destination CPU unit and information about compression/non-compression option, and sequentially creating the destination CPU selection table.

14. The program file management method according to claim 13, further comprising determining based on the parameters of the command and the table information in the address management table whether the command can be set or not, and issuing a warning message if the command cannot be set.

15. The program file management method according to claim 11, further comprising, in response to addition of a new CPU unit, adding a new registration field to the address management table with previous information left as it is, and also clearing all previous information in the destination CPU selection table and then adding a new registration field thereto, to thereby automatically reconstruct the address management table and the destination CPU selection table.

16. The program file management method according to claim 11, further comprising controlling display of the table information in the address management table and the destination CPU selection table.

17. The program file management method according to claim 11, further comprising, on detection of anomaly in the starting program file, looking up the destination CPU selection table to determine which CPU unit has a normal program file stored in the saving area thereof, reading out the normal program file, transferring the normal program file to the saving area of its own memory to be written into the saving area, performing the switchover between the starting and saving areas, and then starting its own CPU unit by executing the normal program file.

18. The program file management method according to claim 11, wherein, if the saving area of the memory has a capacity smaller than that of the starting area, a compressed program file stored in the saving area is transferred to the starting area and stored therein by first stopping an operation in accordance with the program file under execution and then transferring the compressed program file to the starting area, while decompressing the program file, to be written into the starting area.

19. A WDM node for performing WDM communication, comprising:
an OADX for subjecting an optical signal to optical cross-connect control to multiplex and demultiplex the optical signal; and
a communication device including a plurality of CPU units each for performing, with respect to a memory provided therein and having a starting area and a saving area as program file storage areas, a switchover from the saving area to the starting area and performing an operation in accordance with a program file stored in the starting area, each said CPU unit being operative in response to a program file store instruction to transfer the program file under execution to the saving area of another CPU unit to be stored therein in accordance with table information, a database for holding the table information indicating start addresses of stored program files and destination CPU units in which program files are to be saved, and an operation management unit for performing interfacing of a command from a user and also performing a control process including downloading of program files to said CPU units, registration of the table information in said database and issuance of the program file store instruction.
